(19) United States
(12) Patent Application Publication
(10) Pub. No.: US 2014/0196748 A1
(43) Pub. Date: Jul. 17, 2014

(54) PROTECTIVE DEVICES AND METHODS FOR PRECISION APPLICATION OF CLEANING POLYMER TO OPTICS

(71) Applicant: CALIFORNIA INSTITUTE OF TECHNOLOGY, Pasadena, CA (US)

(72) Inventors: Margot H. PHELPS, Altadena, CA (US); Kaitlin E. GUSHWA, Pasadena, CA (US); Eduardo J. SANCHEZ, Los Angeles, CA (US); Calum I. TORRIE, Pasadena, CA (US)

(73) Assignee: CALIFORNIA INSTITUTE OF TECHNOLOGY, Pasadena, CA (US)

(21) Appl. No.: 14/150,421

(22) Filed: Jan. 8, 2014

Related U.S. Application Data
(60) Provisional application No. 61/751,612, filed on Jan. 11, 2013.

(51) Int. Cl. B08B 7/04; B08B 3/02; B05B 1/02; B08B 1/00

(52) U.S. Cl. CPC B08B 7/04; B08B 1/002; B08B 3/02; B05B 1/02
USPC 134/6; 239/589

(57) ABSTRACT

Novel devices and methods for cleaning optics are disclosed. A polymer can be sprayed onto the surface of an optic to capture contaminants. A spray cone can be used to limit the area of the polymer application. As the polymer solidifies, contaminants are captured and subsequently removed together with the polymer.

### CROSS REFERENCE TO RELATED APPLICATIONS

The present application claims priority to U.S. Provisional Patent Application No. 61/751,612, filed on Jan. 11, 2013, the disclosure of which is incorporated herein by reference in its entirety.

### STATEMENT OF INTEREST

This invention was made with government support under PHY0328418 and PHY0823459 awarded by the National Science Foundation. The government has certain rights in the invention.

### TECHNICAL FIELD

The present disclosure relates to cleaning of optical elements in a cleanroom environment. More particularly, it relates to protective devices and methods for precision application of cleaning polymer to optics.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 illustrates an exemplary cone in a retracted position.

FIG. 2 illustrates an exemplary cone in the in-service position.

FIG. 3 illustrates an exemplary cone.

FIG. 4 illustrates an exemplary cone from a side view.

FIG. 5 illustrates an exemplary rig for position adjustment of a cone.

FIG. 6 illustrates an exemplary rig attached to an optic assembly.

FIG. 7 illustrates an example of brushing on additional polymer.

FIG. 8 illustrates an exemplary cone assembly.

FIG. 9 illustrates an exemplary flowchart for a method of cleaning optics.

### SUMMARY

In a first aspect of the disclosure, a method to clean optics is described, the method comprising: attaching a spray cone to an optic, the spray cone delimiting an area of the optic to be sprayed; mixing a polymer and a solvent in a desired ratio, thereby obtaining a polymer solution; spraying the polymer solution on an area of the optic delimited by the spray cone, thereby obtaining a sprayed polymer area, the sprayed polymer area comprising a central area and an edge area; removing the spray cone; brushing an additional layer of the polymer solution on the edge area of the sprayed polymer area; removing the sprayed polymer area, thereby removing contaminants from the optic; and inspecting the optic for any remaining contaminants.

In a second aspect of the disclosure, a spray cone is described, the spray cone comprising: a sheet wrapped into a truncated cone shape, the truncated cone shape comprising a large base end and a small base end; plungers, wherein the plungers are configured to allow movement of the spray cone towards and away from a surface of an object; and thumb screws, wherein the thumb screws are configured to allow movement of the spray cone towards and away from the surface with a finer adjustment control than the movement allowed by the plungers.

### DETAILED DESCRIPTION

The present disclosure relates generally to optical contamination control, for example in a cleanroom environment. For example, fused silica optics in the Advanced Laser Interferometer Gravitational-Wave Observatory (LIGO) detectors are extremely sensitive to optical scattering and absorption losses induced by both particulate and hydrocarbon contamination. Any contamination can substantially damage the optics when irradiated by the high intensity lasers used during operation.

Therefore, it is very important to properly maintain the optical elements in a clean state. Cleaning procedures can often introduce additional contaminants or scratch the delicate optics while removing other contaminants. Special methods and devices may be needed in specific situations. For example, in ultra-high vacuum (UHV) systems, specific cleaning procedures may be required. The present disclosure describes cleaning procedures which are suitable for cleanrooms and in ultra-high vacuum (UHV) systems.

In certain situations, such as during cleaning of the silica optics in the LIGO detectors, it may be necessary to quickly remove the maximum number of particulates from suspended optics inside a cramped vacuum chamber without introducing additional contaminants into the chamber during the process.

In the present disclosure, devices and methods are described to perform cleaning with a cleaning polymer. For example, the polymer called First Contact™ (FC) can be used. First Contact™ is a mixture of solvent and polymer that is applied in liquid form to an optical surface, allowed to dry, and then removed to leave a clean optic. As the person skilled in the art will understand, any other polymer with similar characteristics may be used to perform the methods of the present disclosure. The polymer can capture contaminants on the optics surface during solidification, and when the polymer is removed, the contaminants are also removed. The contaminants can be removed without affecting the optical coating. In the present disclosure, the terms first contact polymer can be used interchangeably with the terms First Contact polymer and First Contact™ polymer.

One advantage of the FC polymer, and therefore a desired characteristic of any substitute polymer, is that it leaves no measurable residue. Another advantage is that outgassing of FC is not significant.

The FC polymer may be coated onto an optic in several ways, for example by brushing, spraying or pouring. Brushing may damage optics with sensitive surfaces by dragging contaminants across the surface, resulting in scratches. Therefore it may be advantageous to employ a non-contact application like spraying or pouring. Spraying or pouring may be termed non-contact applications, opposed to brushing, as the only contact during spraying or pouring is between polymer and optics.

The application of polymer necessitates particular care as the optimal quantity of polymer should reach the surface of an optical element. Too much polymer may be harder to remove, while not enough polymer may break easily and be difficult to remove entirely.

The content ratio between solvent and actual polymer may also be carefully determined: if there is too much polymer in solution then it will dry almost the instant it comes out of the spray nozzle, creating cobwebs of polymer that can contaminate a vacuum chamber around the optic that is being cleaned.

In some embodiments, a spray cone is employed to protect the equipment surrounding an optic. For example, a polymer may be sprayed on an optic, and if some polymer is sprayed or leaks outside a desired area on the optic, then that polymer will be blocked by the spray cone instead of causing contamination. The spray cone can then be removed and cleaned separately outside a vacuum chamber. In the present disclosure, the spray cone is referred to as a cone for ease of expression, as its shape is referred to with geometric accuracy as a truncated cone. Therefore, in the present disclosure a truncated cone can be addressed to as a cone. As understood by the person skilled in the art, a truncated cone has a large base end and a small base end, where the two ends are intended as geometrical but not material ends. In other words, the truncated cone has no material on either end, in order to allow the polymer to be sprayed through the truncated cone, generally along the direction of its axis.

In some embodiments, the optimal spray mix and bottle are a 3 oz High-density polyethylene (HDPE) bottle and atomizing nozzle, filled with a 1:1 ratio of red First Contact™: red FC thinner. This mix lowers the polymer content enough to avoid cobwebs. When coupled with good technique and use of the protective spray cones, back splatter in chamber can be avoided.

The protective cones can be used in a similar fashion with different solvents or mix ratios, or for other applications.

A simple, clean, precise, repeatable method for cleaning optics was created around the idea of using a conical fixture with a spray polymer formula. The device, comprising a rig and a cone, serves two purposes: Template—Yields uniform and consistently sized films of repeatable diameter; Shield—Not only protects the optic from overspray, but also the suspensions, wire, fibers, cables, and surrounding area from polymer.

In some embodiments, the protective spray cones make a seal against the surface of the optical surface using cleanroom wipes where it actually contacts, to prevent polymer drips from spray. Therefore, cleanroom wipes are used between the cone and the machine housing the optic, in order to prevent any polymer from seeping through any gap.

The spray cones can bolt straight to the structure which houses the optic, called a suspension structure. This leaves hands free to apply the cleaning polymer. The spray cones can also have a small enough footprint to avoid hitting any of the other optics and equipment that are nearby.

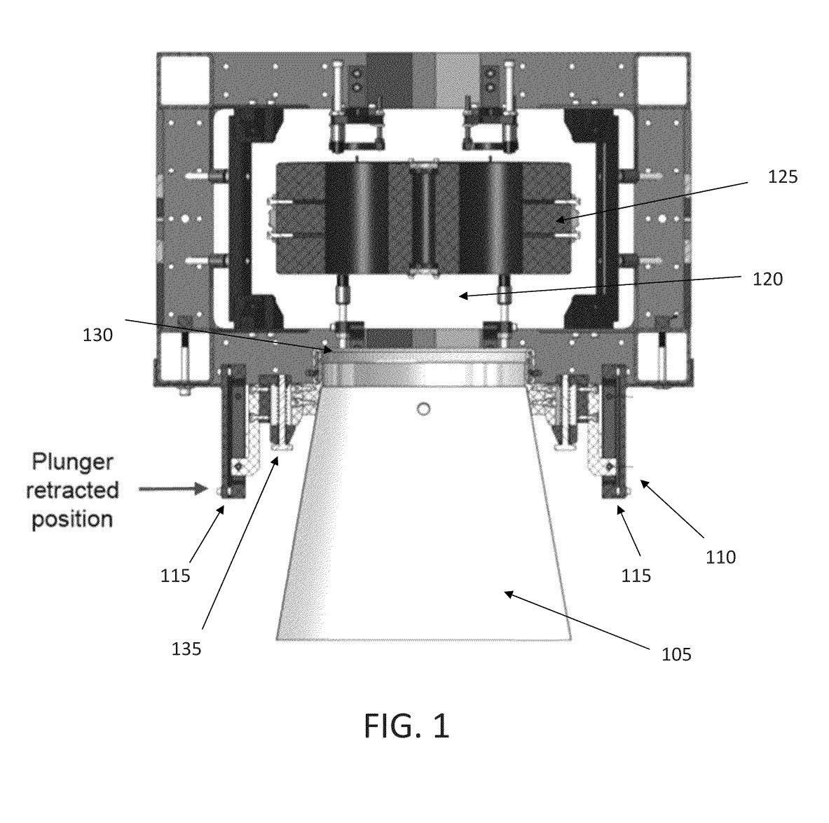

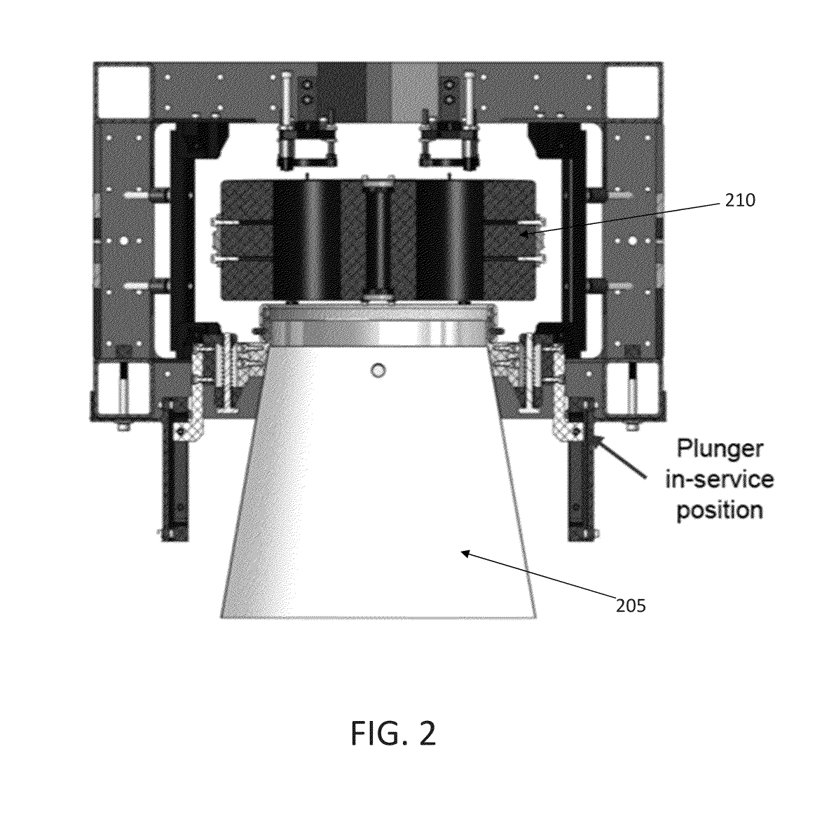

As illustrated in FIG. 1, a spray cone (105) may be attached to a rig (110). Part of the rig (110) may comprise contain retractable spring plungers (115) or other types of plungers, and adjustable thumb screws (135). Such plungers (115) and screws (135) allow the movement of the cone (105) from a retracted position to a contact position, in contact with the optic. FIG. 1 illustrates an example of a retracted cone (105), with a gap (120) present between the cone (105) and the optic (125). FIG. 2 illustrates an example of a cone (205) in the in-service position, where no gap is present between the cone (205) and the optic (210).

In order to be applied to optics of different sizes with different laser beam path sizes, several sizes of cones can be used. In other words, the size and location of the laser beams can determine the size of the cones. In some embodiments, the cones are made from High-Density Polyethylene (HDPE), and are held together by metal fasteners. HDPE does not react with First Contact, and is approved for use in cleanrooms. Different types of fasteners may be used. Different materials may also be used for the cones. In some embodiments, non-metal materials may have the advantage of not shedding metallic contaminants. A soft cleanroom-compatible wipe can be folded and fit over the smaller end of the cone, which rests against the optic face. For example, referring to FIG. 1, the wipes may be wrapped around the end (130) of the cone (105) to form a seal between the cone (105) an optic (125) without scratching the optic.

A polymer mixture can be sprayed onto a circular area of the optic face within the area demarked by the cone. Excess polymer is contained by the cone walls and absorbed into the wipe folded onto the cone and resting between the cone and the optic.

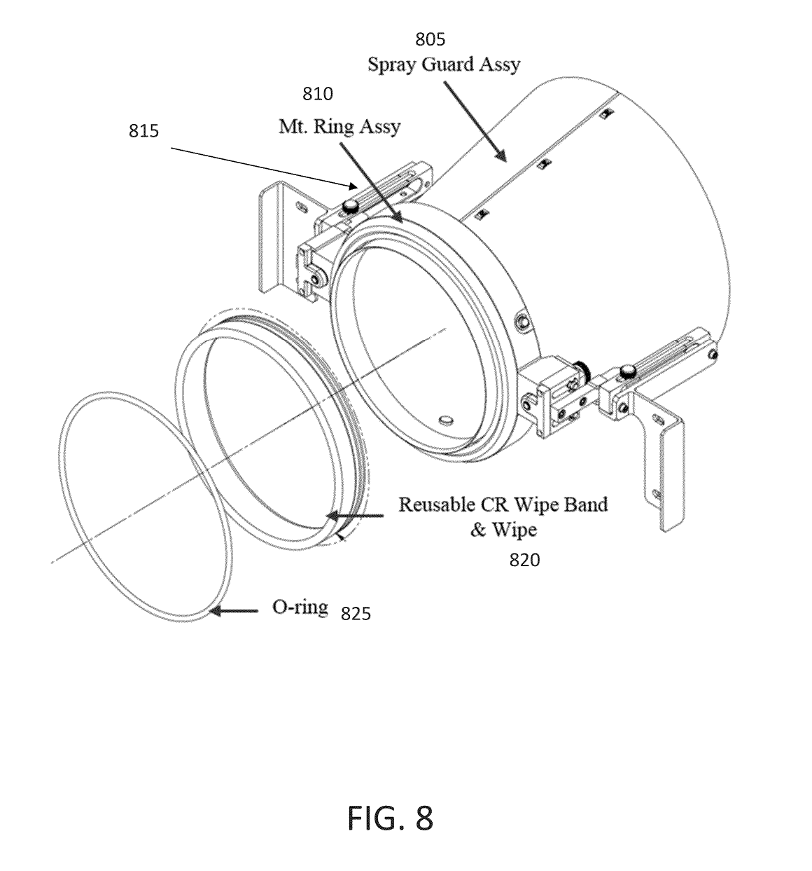

If a wipe is cut before folding, the edges are folded around an HPPE band (such as element 820 in FIG. 8) and secured with Kapton® tape in such a way that no frayed edges or tape are exposed on the outside of the wipe. This prevents the shedding of fibers into the vacuum chamber or onto the optic's surface. The wipe and band combination should then be wrapped tightly around the cone, in order to avoid an uneven surface which may leave gaps between the optic's surface and the cone. The wipe can be secured to the cone with a Viton O-ring. The HDPE band can preserve the shape of the folded wipe, and prevent it from deforming, so that does not contact the optic directly.

Having wrapped the wipe around the spray cone, the cone can be moved into position. For example, the spray cone assembly may have coarse adjustment controls to approach the cone to the optic, and fine adjustment controls that operate the cone once it's close to the optic, in order to adjust the alignment with accuracy. In some embodiments, a retractable spring plunger can be used for coarse position adjustment, and a thumb screw for fine adjustment. For example, referring to FIG. 1, plungers (115) and screws (135) can be used for position adjustment.

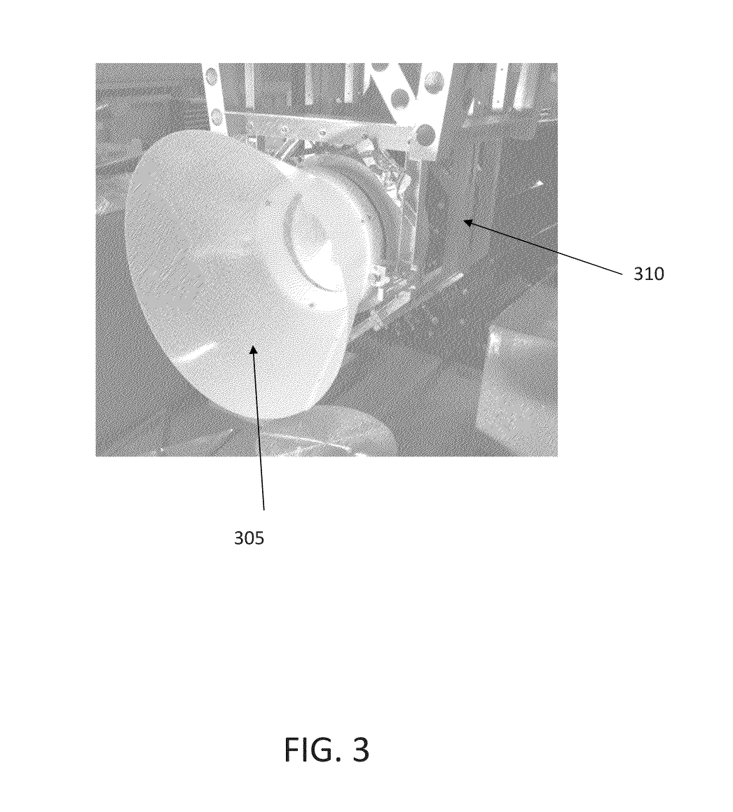

FIG. 3 illustrates an exemplary cone (305) attached to an optic assembly (310).

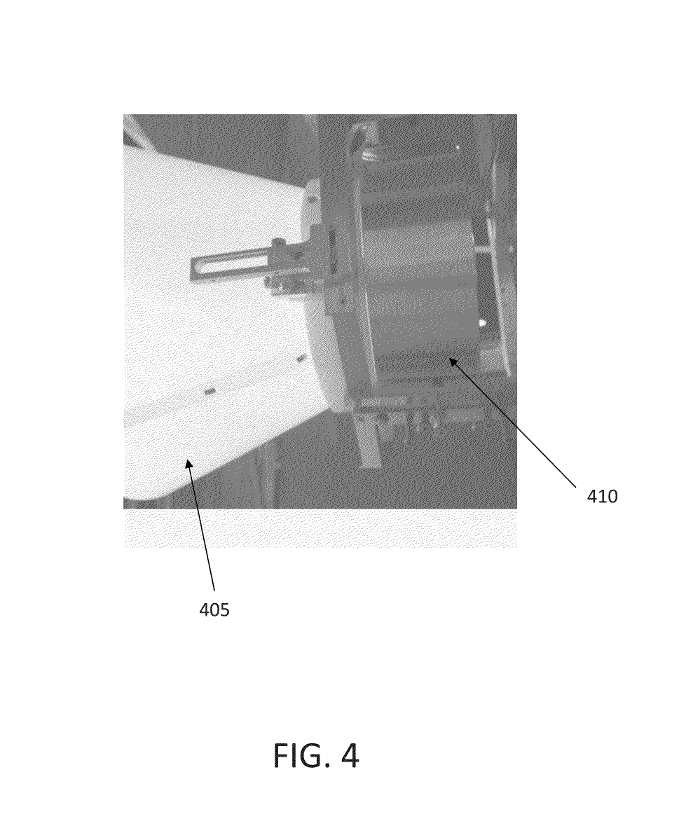

FIG. 4 illustrates an exemplary cone (405) attached to an optic assembly (410) from a side view.

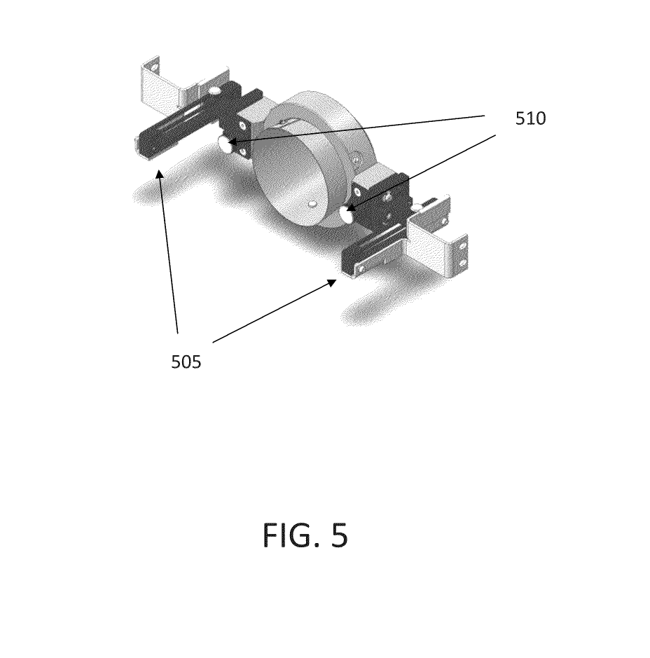

FIG. 5 illustrates an exemplary rig for position adjustment of a cone. Plungers (505) and thumb screws (510) are illustrated.

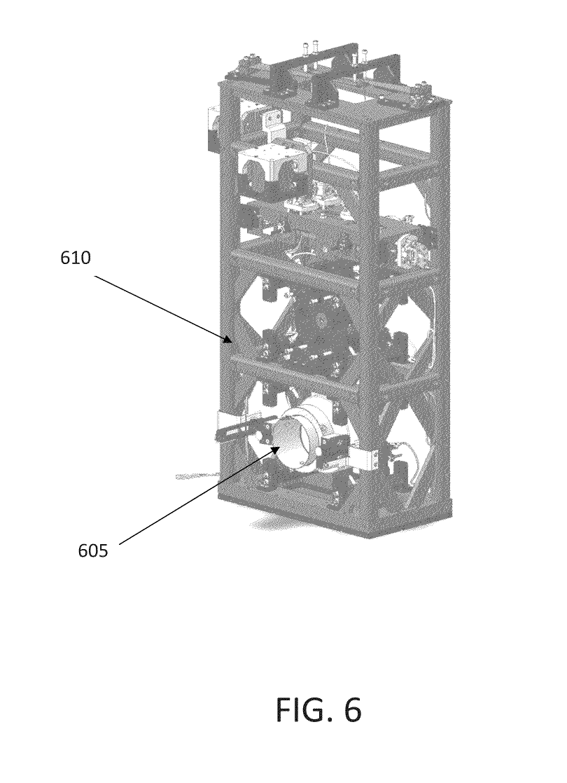

FIG. 6 illustrates an exemplary rig (605) attached to an optic assembly (610).

In some embodiments, a spray cone may first be prepared for use in a cleanroom according to the following procedure:

1. Sonic clean in deionized (DI) water for 10 minutes.

2. Sonic clean in a 10% mixture of Liquinox® and DI water for 10 minutes.

3. Rinse in DI water for 10 minutes.

4. Wipe dry with a dustless cleanroom wipe.

5. Wipe with isopropyl alcohol and cleanroom wipe.

6. Allow to dry for 20 minutes.

Subsequently, a cleanroom wipe may be attached to smaller end of the spray cone, as described previously. In a following step, the polymer (such as FC) may be prepared for spraying according to the desired solvent to polymer ratio.

For example, the following procedure may be used:

1. Rinse out a clean graduated cylinder or beaker with acetone.

2. Rinse or wipe out a clean spray bottle with Red First Contact Thinner™ or acetone before first use.

3. Use the graduated cylinder or beaker to measure out 1 part Red First Contact™ to 1 part Red First Contact Thinner™. Pour mix into the clean spray bottle. Replace the cap (not nozzle) on the bottle.

In a subsequent step, the nozzle of the bottle is flushed:

1. Fill a clean spray bottle with Red First Contact Thinner (or other appropriate solvent).

2. Screw a nozzle onto the thinner bottle.

3. Spray into a wipe until the spray is completely clear. Then swap the cap on the mixed polymer bottle for the nozzle on the thinner bottle.

To flush the nozzle, acetone can also be used instead of Red First Contact Thinner. Other chemicals which are incompatible with the polymer or bottle being used in the procedure should not be used.

A test spray can then be performed prior to the actual polymer application. For example, the nozzle may be pumped into the wipe until the spray is pink. A user can practice spraying a vertical surface (ex: foil or plate glass) to get a feel for the nozzle and ascertain its functionality. Spray can be a fine mist.

Subsequently, the spray cone assembly can be bolted onto the suspension structure and then sealed against the optic.

The polymer can be sprayed onto an optic for example by holding the nozzle 3 or 4 inches away from the optic's surface. A full coverage of the optic's surface can be sprayed in one application. A user may have a natural tendency to move the bottle further away when spraying towards the edges of the cone. This can result in spider webs and possibly overspray of the polymer. A second person can observe the sprayer to ensure proper nozzle distance.

A second application of polymer may be applied, preferably after waiting about 2-5 minutes to allow the first layer to set, that is to start solidifying and be solid enough for a second application. After waiting 2-5 minutes for the polymer to set, a third layer of polymer can be applied.

Subsequently, the spray cone and rig can be removed.

In a following step, additional polymer can be added around the perimeter of the circular optic area covered by the polymer. This extra polymer can be added for example with a brush, such as a brush with an aluminum handle and HDPE bristles. Normal brushes may have adhesives and materials that react with FC, and then contaminate the optic, therefore an appropriate brush may be used devoid of these adhesive and materials. This extra layer of polymer around the edges can resemble a piecrust shape. In other words, the sprayed polymer area comprises a central area and an edge area, the edge area comprising the edge of the sprayed disk as well as part of the disk close to the edge. In some embodiments, the edge area is outside the beam path, to avoid brushing over a contaminant. Brushing over a contaminant may scratch the optic, with subsequent damage due to the laser beam. Brushing outside the beam path can prevent damage due to the laser beam.

The outer edge of the sprayed polymer (such as FC) can be thickened so the entire film can be pulled off in one piece when it dries. It may be advantageous to get as much polymer on a custom brush as possible without dripping, and carefully paint a ring, or pie crust. Since the polymer is being brushed after removal of the spray cone, the polymer layer (shaped like a disk) will have its outer edges accessible. Therefore, the brush can be centered over the edge of the sprayed polymer disk, so half of the pie crust is inside the polymer circle and half is outside. In other words, the polymer is brushed over the edges of the polymer disk.

It may be advantageous to include all sprayed and thinly covered areas near the perimeter of the sprayed polymer disk, as well as any drips in the crust, even if this means the end result is not a circular crust. Carefully inspection can be carried out to check the crust with a flashlight array to ensure there are no gaps.

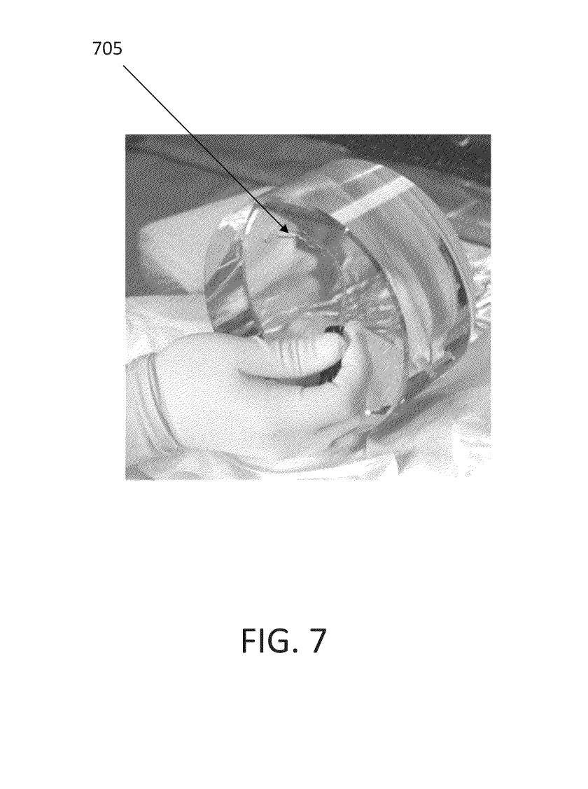

For example, FIG. 7 illustrates an example of brushing on additional polymer (705). In some embodiments, brushing may involve: allowing 5-10 minutes for the crust to dry; laying the brush on cleanroom wipes, and spraying with polymer thinner; and using a wipe to remove excess polymer from the brush until it is clean. Subsequently, the method may involve gently touching the first crust with the clean brush. If the polymer feels tacky, it may be necessary to allow additional time to dry. When the first crust is dry, a user can paint a second pie crust directly over the first, allowing 5-10 minutes to dry, and cleaning the brush again. Subsequently, a third crust can be painted directly over the first.

In a subsequent step, a polyether ether ketone PEEK mesh tab can be applied over the applied polymer's surface. While the third pie crust is still wet, the PEEK mesh strip can be placed against the crust on either side of the optic (in the 2-4 o'clock or 8-10 o'clock regions). For example, about half of the PEEK can be on the crust, and half can extend past it. It may be advantageous to hold the PEEK tab with one hand, and use the other hand to dab polymer onto the portion of the strip that is on the crust with the custom brush. Subsequently, the polymer can be removed from the optic. For example, the dry polymer film can be pulled on gently and slowly using the PEEK tab while spraying nitrogen at the separation surface between the polymer and the optic. Nitrogen can be sprayed using an ion gun.

FIG. 8 illustrates an exemplary cone assembly, comprising a spray guard assembly (805), a mounting rig assembly (810), plungers (815), a reusable band for holding cleanroom (CR) wipes (820) and an O-ring (825) which may be used to improve the seal between a spray cone and an optic.

In other embodiments, more than two layers of polymer may be sprayed, for example three layers. In other embodiments, only one layer may be needed, or more than three. Different drying times may be necessary depending on the application.

The PEEK tab can also be applied to an already dry film. When the polymer is applied to the PEEK tab over the dry FC film, it can recombine into a new layer comprising the PEEK tab. However, it may save time to add the strip after applying the third crust while the polymer is still not completely dry.

The PEEK tab can be allowed to dry on the film for about one hour.

In a subsequent step, holding an ion gun in one hand, a user can slowly start to peel the PEEK mesh tab off the surface of the optic. The optic may become charged and attract contaminants, therefore the use of an ion gun may be advantageous. As soon as the dry polymer film begins to detach from the optical surface, a user can start blowing high purity nitrogen gas from the ion gun onto the optic. A user can hold the gun parallel to the optic face, focusing on the area where the film is detaching from the optic. A user can pay close attention to the edges when peeling to ensure nothing is left behind on the optic.

If the polymer does not start to come off in a single piece as the tab is pulled, it may be advantageous to stop and re-apply a thick FC crust. If the polymer is broken into pieces during removal, contamination will likely occur from small pieces of polymer remaining on the optic's surface.

A flashlight array can be used after removal of the polymer to inspect the optic and ensure that all polymer has been removed.

In some embodiments, a thin layer of polymer is used, to allow for example laser alignment to be carried out through the optic, which would damage thicker layers of polymer and the attached optic. The polymer can be thickened to facilitate removal, after the alignment has been carried out.

Spot brushing can be used to thicken any portion of polymer that has been left onto the optic's surface. Alternatively, a wipe imbued with acetone can be used to remove small portions of polymer.

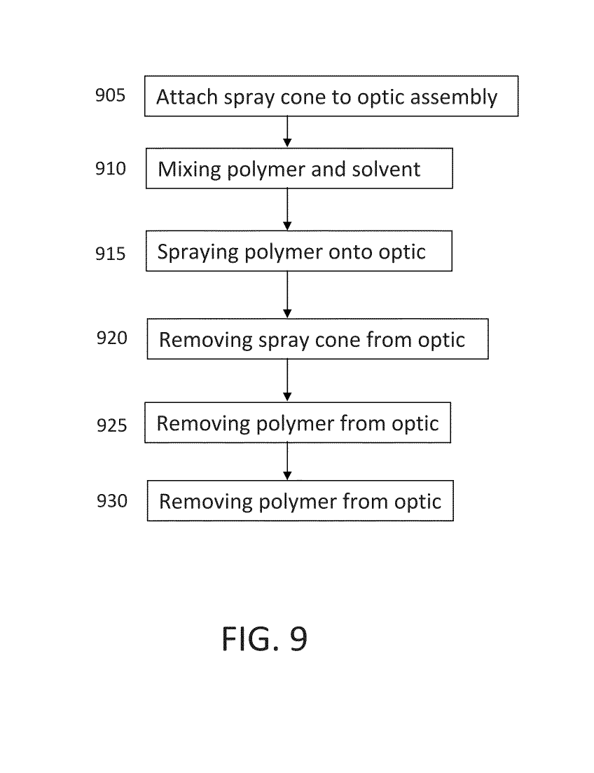

Therefore, as described in the present disclosure and referring to FIG. 9, a method to clean optics may comprise: attaching a spray cone to an optic assembly (905); mixing polymer with solvent in a desired ratio (910); spraying polymer onto the optic (915); removing spray cone from optic (920); removing polymer from optic (925); inspecting the optic (930). In other embodiments, an additional step may be present after step (920), the additional step comprising painting a polymer crust onto the optic.

A number of embodiments of the disclosure have been described. Nevertheless, it will be understood that various modifications may be made without departing from the spirit and scope of the present disclosure. Accordingly, other embodiments are within the scope of the following claims.

In some embodiments, the cone can be adjusted by sliding towards the optic and away from the optic through the use of plungers and thumb screws. Holes may be present to allow the cone to set at specific positions in order to prevent the cone from hitting the optic by sliding out of position.

In some embodiments, the spray cones are not affixed to an optic but to another surface to be cleaned, for example a semiconductor wafer.

The examples set forth above are provided to those of ordinary skill in the art as a complete disclosure and description of how to make and use the embodiments of the disclosure, and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

What is claimed is:

1. A method to clean optics, the method comprising:
attaching a spray cone to an optic, the spray cone delimiting an area of the optic to be sprayed;
mixing a polymer and a solvent in a desired ratio, thereby obtaining a polymer solution;
spraying the polymer solution on an area of the optic delimited by the spray cone, thereby obtaining a sprayed polymer area, the sprayed polymer area comprising a central area and an edge area;
removing the spray cone;
brushing an additional layer of the polymer solution on the edge area of the sprayed polymer area;
removing the sprayed polymer area, thereby removing contaminants from the optic; and
inspecting the optic for any remaining contaminants.

2. The method of claim 1, wherein the spray cone comprises a sheet wrapped into a truncated cone shape and comprises:
a large base end;
a small base end, the small base closer to the optic than the large base;
plungers, wherein the plungers are configured to allow movement of the spray cone towards and away from the optic; and
thumb screws, wherein the thumb screws are configured to allow movement of the spray cone towards and away from the optic with a finer adjustment control than the movement allowed by the plungers.

3. The method of claim 2 further comprising placing a cleanroom wipe between the spray cone and the optic, the cleanroom wipe being wrapped around the edges of the small base end.

4. The method of claim 1, wherein the desired ratio is 1:1 polymer to solvent ratio and wherein the polymer is a first contact polymer.

5. The method of claim 4, wherein the spraying the polymer solution comprises spraying more than one layer of polymer solution, and further comprising allowing the polymer solution to partially dry inbetween spraying of layers.

6. The method of claim 1, wherein the brushing comprises forming a piecrust shape on the edge area of the sprayed polymer area.

7. The method of claim 5, wherein the allowing the polymer solution to partially dry comprises a dry time of 5 minutes.

8. The method of claim 1, further comprising applying a mesh tab on the sprayed polymer area before the removing.

9. The method of claim 8, wherein the mesh tab is a polyether ether ketone mesh tab.

10. The method of claim 1, wherein the removing comprises peeling the sprayed polymer area while spraying nitrogen on the optic with an ion gun.

11. The method of claim 5, wherein the inspecting comprises shining an array of flashlights onto the optic.

12. A spray cone comprising:
a sheet wrapped into a truncated cone shape, the truncated cone shape comprising a large base end and a small base end;
plungers, wherein the plungers are configured to allow movement of the spray cone towards and away from a surface of an object; and
thumb screws, wherein the thumb screws are configured to allow movement of the spray cone towards and away from the surface with a finer adjustment control than the movement allowed by the plungers.

13. The spray cone of claim 12, wherein the sheet is made of a plastic material.

14. The spray cone of claim 12, wherein the plungers are retractable spring plungers.
